(19) United States
(12) Patent Application Publication
(10) Pub. No.: US 2018/0238646 A1
(43) Pub. Date: Aug. 23, 2018

(54) Methods For Negating Deposits Using Cavitation Induced Shock Waves

(71) Applicants: Larry Baxter, Orem, UT (US); David Frankman, Provo, UT (US); Aaron Sayre, Spanish Fork, UT (US); Nathan Davis, Bountiful, UT (US)

(72) Inventors: Larry Baxter, Orem, UT (US); David Frankman, Provo, UT (US); Aaron Sayre, Spanish Fork, UT (US); Nathan Davis, Bountiful, UT (US)

(21) Appl. No.: 15/440,343

(22) Filed: Feb. 23, 2017

(51) Int. Cl. F28G 7/00; B08B 7/02; B08B 7/00; B08B 3/12; B08B 9/032; F28G 15/00; F28G 13/00

(52) U.S. Cl. CPC F28G 7/00; B08B 7/02; B08B 7/0064; F28G 13/005; B08B 9/0325; F28G 15/003; B08B 3/12

(57) ABSTRACT

A method for removing a surface foulant is disclosed. An operating heat exchanger is provided. A carrier liquid that contains potential fouling agents is provided to the heat exchanger. The potential fouling agents foul at least a portion of the heat exchanger. The exchanger is operated such that the carrier liquid is at a vapor pressure equal to the operating pressure. Cavitation inducing devices are provided to the exchanger. A condition indicating fouling is detected. The cavitation inducing devices are operated on a portion of the exchanger to cause a localized pressure change, vaporizing a portion of the carrier liquid and forming a transient bubble or bubbles which collapse by cavitation, producing a localized shockwave, a re-entrant microjet, and extreme transient pressures and temperatures. These steps are repeated as necessary to remove the surface foulant. In this manner, the surface foulant is removed from the operating heat exchanger.

This invention was made with government support under DE-FE0028697 awarded by The Department of Energy. The government has certain rights in the invention.

### BACKGROUND

### Field of the Invention

This invention relates generally to the field of maintenance and operation of heat exchangers. Our interest is more particularly in the removal of foulants from operating heat exchangers.

### Background

Fouling of heat exchangers is an issue that occurs in all types of heat exchange processes. The cost of cleaning includes operational time lost, actual cleaning time, and replacement of equipment beyond cleaning. Cleaning techniques rely on the heat exchangers being shut down, drained, and dismantled. Effective cleaning of heat exchangers by non-chemical means or during operations are not available presently.

Cavitation is a phenomenon in industrial fluid flows that is normally avoided. Cavitation often causes surface destruction of pipes, impellers, and other equipment. Designs of equipment focus on removing any potential cavitation from the equipment. No foulant removal system for use on operating equipment currently employs cavitation.

New methods for removing fouling from heat exchangers, especially during operations, are needed.

United States patent publication number 20080073063 to Clavenna et al. teaches a method for reducing fouling and the formation of deposits on the inner walls of direct-contact heat exchangers. The method is comprised of applying fluid pressure pulsations to the liquids within tubes of the heat exchanger with vibrations to the heat exchanger to affect a reduction of the viscous boundary layer. Reduction of the viscous boundary layer reduces the incidence of fouling as well as promotes heat transfer from the tube wall to the liquid within the tubes. The method is also comprised of the use of a coating on the inner wall surfaces of exchanger tubes to further reduce fouling and corrosion. The present disclosure differs from this in that the exchanger can be operating, does not require fluid pressure pulsations, and does not require any special surface materials. This disclosure is pertinent and may benefit from the methods disclosed herein and is hereby incorporated for reference in its entirety for all that it teaches.

U.S. Pat. No. 4,120,699 to Kennedy et al. teaches a method for acoustical cleaning comprising immersing the equipment in a liquid and propagating opposing acoustic wave trains to produce directed cavitation. The present disclosure differs from this in that the exchanger can be operating and does not require immersion in a separate fluid bath. This disclosure is pertinent and may benefit from the methods disclosed herein and is hereby incorporated for reference in its entirety for all that it teaches.

United States patent publication number 20116290778 to Zugibe teaches a method for sonic cleaning of a heat exchanger comprising insertion of an ultrasonic transducer and a liquid medium within the shell of the heat exchanger. The ultrasonic transducer is excited, to produce acoustic waves within the liquid. The present disclosure differs from this in that the exchanger can be operating, requiring no shut down or special fluids. This disclosure is pertinent and may benefit from the methods disclosed herein and is hereby incorporated for reference in its entirety for all that it teaches.

U.S. Pat. No. 9,032,792 to Bradley et al. teaches a fouling reduction device and method. An ultrasound emitter is used to reduce fouling on a sensor in a liquid. The present disclosure differs from this in that the fouling is not reduced, but actually removed. This disclosure is pertinent and may benefit from the methods disclosed herein and is hereby incorporated for reference in its entirety for all that it teaches.

U.S. Pat. No. 8,628,660 to Foret teaches treatment of fluids with wave energy from a carbon arc. The carbon arc is applied to a hydrocyclone or other vortex and used to cavitate the bulk fluid and destroy biological and other materials. The present disclosure differs from this in that the cavitation occurs on the surface, not in the bulk flow, and does not require a vortex or thin film layers. This disclosure is pertinent and may benefit from the methods disclosed herein and is hereby incorporated for reference in its entirety for all that it teaches.

### SUMMARY

A method for removing a surface foulant is disclosed. An operating heat exchanger is provided, with a process side operating at an operating pressure. A carrier liquid that contains potential fouling agents is provided to the process side of the operating heat exchanger, wherein at least a portion of the potential fouling agents foul at least a portion of an internal wall of the process side of the operating heat exchanger. The process side of the heat exchanger is operated such that the carrier liquid is at a vapor pressure equal to the operating pressure. A cavitation inducing device or cavitation inducing devices are provided to the process side of the operating heat exchanger. A condition indicating fouling is detected. The cavitation inducing device or devices, operating on a portion or portions of the process side of the operating heat exchanger, induce a localized pressure change, vaporizing a portion of the carrier liquid and forming a transient bubble or bubbles which collapse by cavitation, producing a localized shockwave, a re-entrant microjet, and extreme transient pressures and temperatures. These steps are repeated as necessary to remove the surface foulant. In this manner, the surface foulant is removed from the operating heat exchanger.

The process side of the operating heat exchanger may be equipped with pressure sensors, temperature sensors, or a combination thereof. The pressure and temperature sensors may be located at an inlet and an outlet of the process side of the operating heat exchanger.

The condition indicating fouling may be determined by a change of pressure through the operating heat exchanger, indicated by the pressure sensor or pressure sensors, a change of temperature, indicated by the temperature sensor or temperature sensors, or a combination thereof.

The carrier liquid may comprise water, brine, hydrocarbons, liquid ammonia, liquid carbon dioxide, or combinations thereof. The potential fouling agents may comprise solid particles, miscible liquids, dissolved salts, a fouling gas that may desublimate onto the surface of the heat exchanger, reaction products, or combinations thereof. The fouling gas may comprise carbon dioxide, nitrogen oxide, sulfur dioxide, nitrogen dioxide, sulfur trioxide, hydrogen sulfide, hydrogen cyanide, water, hydrocarbons with a freezing point above 0 C, or combinations thereof.

The cavitation inducing device or cavitation inducing devices may comprise a piezoelectric actuator, ultrasound emitter, carbon-arc cavitation inducer, voice coil, linear resonant actuator, shaker, exciter, hydraulic actuator, solenoid actuator, blunt object, manual shaking, or a combination thereof. The cavitation inducing device or cavitation inducing devices may be sealed to prevent a liquid from damaging the cavitation inducing device.

The operating heat exchanger may be equipped with a cavitation detecting device or devices. The cavitation detecting device or devices may comprise hydrophones, passive cavitation detectors, piezoelectric polymer-coated impedance-matched acoustical absorbers, vibration sensors, microphones, pressure sensors, ceramic capacitive measuring cells, photolitographed-micropattern cavitation detectors, two electrodes isolated from each other by an insulative surface, high intensity focused ultrasound transducers with a modular cavitation element, or combinations thereof.

The cavitation inducing device or cavitation inducing devices may be controlled by a control loop that monitors the condition indicating fouling and actuates the cavitation inducing device or cavitation inducing devices automatically. The condition indicating fouling may be detected by an operator, at which point the operator may manually actuate the cavitation inducing device or cavitation inducing devices. The operator may directly use the cavitation inducing device or cavitation inducing devices on the operating heat exchanger.

The heat exchanger may comprise a brazed plate, aluminum plate, shell and tube, plate, plate and frame, plate and shell, spiral, or plate fin style heat exchanger. Any surface of the process side of the heat exchanger exposed to the carrier liquid may comprise a material that inhibits adsorption of gases, prevents deposition of solids, or a combination thereof. The material may comprise aluminum, stainless steel, polymers, carbon steel, ceramics, polytetrafluoroethylene, polychlorotrifluoroethylene, natural diamond, man-made diamond, chemical-vapor deposition diamond, polycrystalline diamond, or combinations thereof.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 shows a process flow diagram representing the foulant removal process through the heat exchanger.

FIG. 2 shows a process flow diagram representing the foulant removal process through the heat exchanger.

FIG. 3 shows a process flow diagram representing the foulant removal process through the heat exchanger.

FIG. 4 shows a process flow diagram representing the foulant removal process through the heat exchanger.

FIG. 5 shows a series of cross-sections of the internal wall of the process side of the operating heat exchanger.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention.

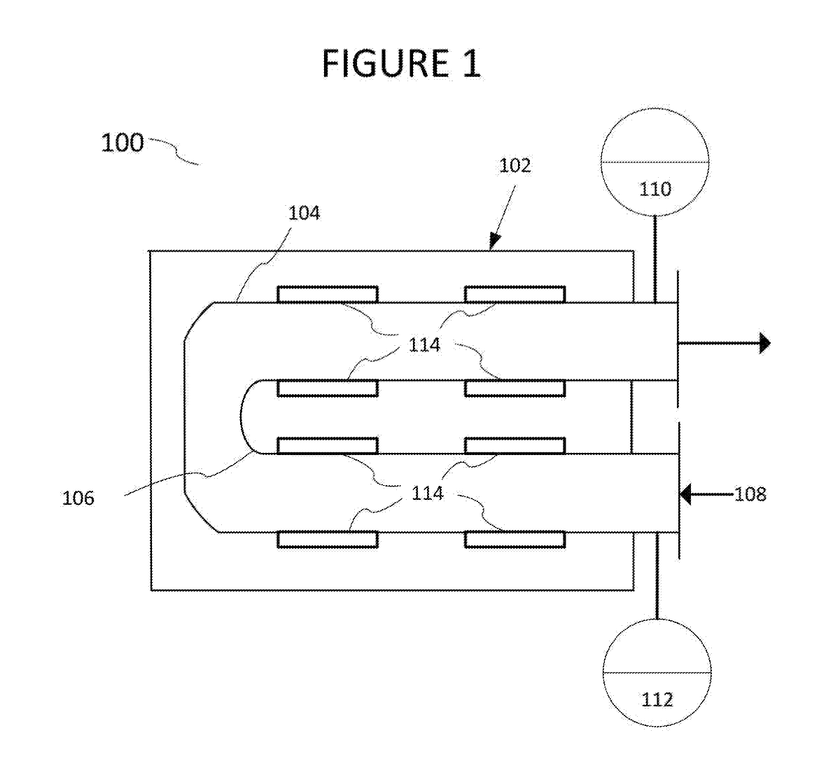

Referring to FIG. 1, a process flow diagram 100 is shown, as per one embodiment of the present invention. Shell and tube style operating heat exchanger 102 is provided with process side 104, containing internal wall 106. Process side 104 is operated at an operating pressure. Carrier liquid 108, which contains potential fouling agents, is provided to process side 104. Heat exchanger 102 is operated in a manner that carrier liquid 108 is at a vapor pressure equal to the operating pressure. The potential fouling agents foul internal wall 104. Device 110 and device 112 detect a condition indicating fouling. Cavitation inducing devices 114 cause a localized pressure change, vaporizing a portion of carrier liquid 108 and forming a transient bubble or bubbles which collapse by cavitation, producing a localized shockwave, a re-entrant microjet, and extreme transient pressures and temperatures against internal wall 106. As internal wall 106 has foulant on it, the cavitation causes removal of the foulant, rather than damage to internal wall 106. This process is repeated as necessary, removing the surface foulant from operating heat exchanger 102.

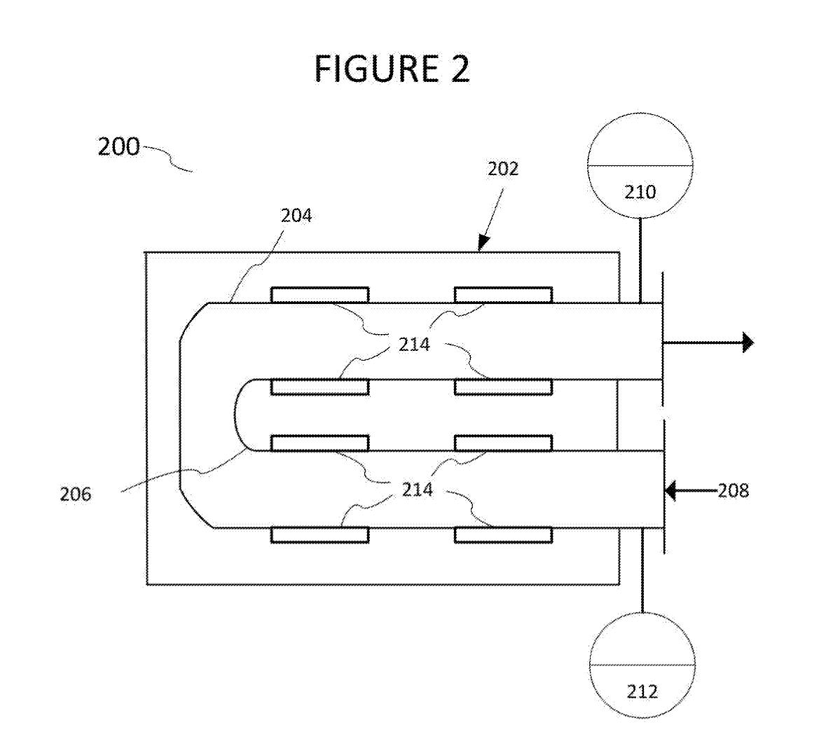

Referring to FIG. 2, a process flow diagram 200 is shown, as per one embodiment of the present invention. Shell and tube style operating heat exchanger 202 is provided with process side 204, containing internal wall 206. Process side 204 is operated at an operating pressure. Water 208, which contains solid particles, is provided to process side 204. Heat exchanger 202 is operated in a manner that water 208 is at a vapor pressure equal to the operating pressure. The solid particles foul internal wall 204. Pressure sensor 210 and temperature sensor 212 detect a change in pressure and temperature, respectively, indicating fouling. Piezoelectric actuators 214 are vibrated to cause a localized pressure change, vaporizing a portion of water 208 and forming a transient bubble or bubbles which collapse by cavitation, producing a localized shockwave, a re-entrant microjet, and extreme transient pressures and temperatures against internal wall 206. As internal wall 206 has solid particles on it, the cavitation causes removal of the solid particles, rather than damage to internal wall 206. This process is repeated as necessary, removing the solid particles from operating heat exchanger 202.

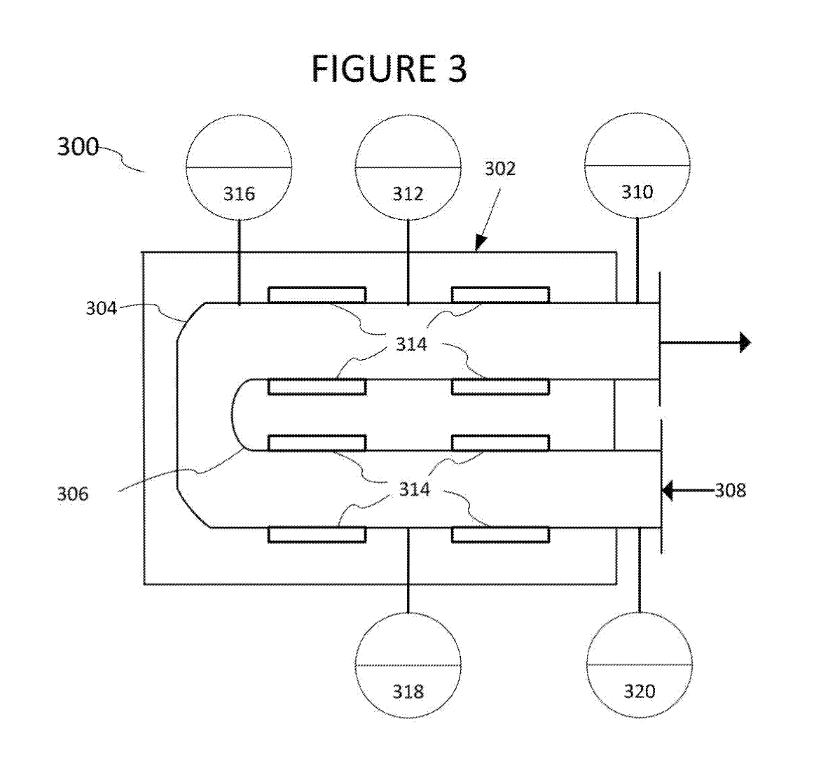

Referring to FIG. 3, a process flow diagram 300 is shown, as per one embodiment of the present invention. Shell and tube style operating heat exchanger 302 is provided with process side 304, containing internal wall 306. Process side 304 is operated at an operating pressure. Isopentane 308, which contains dissolved carbon dioxide, is provided to process side 304. Heat exchanger 302 is operated in a manner that isopentane 308 is at a vapor pressure equal to the operating pressure. The carbon dioxide desublimates to a solid and fouls internal wall 304. Any of pressure sensors 310, 312, 316, 318, and 320 detect a change in pressure, indicating fouling. Piezoelectric actuators 314 are vibrated to cause a localized pressure change, vaporizing a portion of isopentane 308 and forming a transient bubble or bubbles which collapse by cavitation, producing a localized shockwave, a re-entrant microjet, and extreme transient pressures and temperatures against internal wall 306. As internal wall 306 has solid carbon dioxide on it, the cavitation causes removal of the solid particles, rather than damage to internal wall 306. This process is repeated as necessary, removing the solid particles from operating heat exchanger 302. In some embodiments, individual piezoelectric actuators 314 are vibrated based on whether the pressure sensor after was the pressure sensor indicating a pressure change. This allows for directed cavitation to only the portion of internal wall 306 that is actually fouled. In some embodiments, vibration of piezoelectric actuators 314 is replaced by ultrasound induced cavitation by ultrasound emitters.

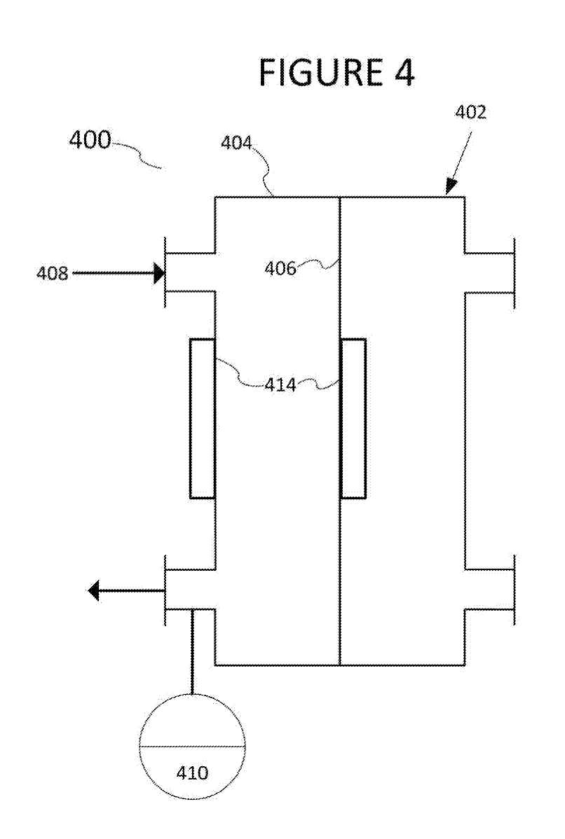

Referring to FIG. 4, a process flow diagram 400 is shown, as per one embodiment of the present invention. Plate style operating heat exchanger 402 is provided with process side 404, containing internal wall 406. Process side 404 is operated at an operating pressure. Brine solution 408 is provided to process side 404. Heat exchanger 402 is operated in a manner that brine solution 408 is at a vapor pressure equal to the operating pressure. The salts in brine solution 408 precipitate out of solution and foul internal wall 304. Pressure sensor 410 detects a change in pressure, indicating fouling. Ultrasound emitters 414 are activated to induce a localized pressure change, vaporizing a portion of brine solution 408 and forming a transient bubble or bubbles which collapse by cavitation, producing a localized shockwave, a re-entrant microjet, and extreme transient pressures and temperatures against internal wall 406. As internal wall 406 has salts on it, the cavitation causes removal of the salts, rather than damage to internal wall 406. This process is repeated as necessary, removing the solid particles from operating heat exchanger 402. In some embodiments, ultrasound induced cavitation by ultrasound emitters 414 is replaced by vibration of piezoelectric actuators.

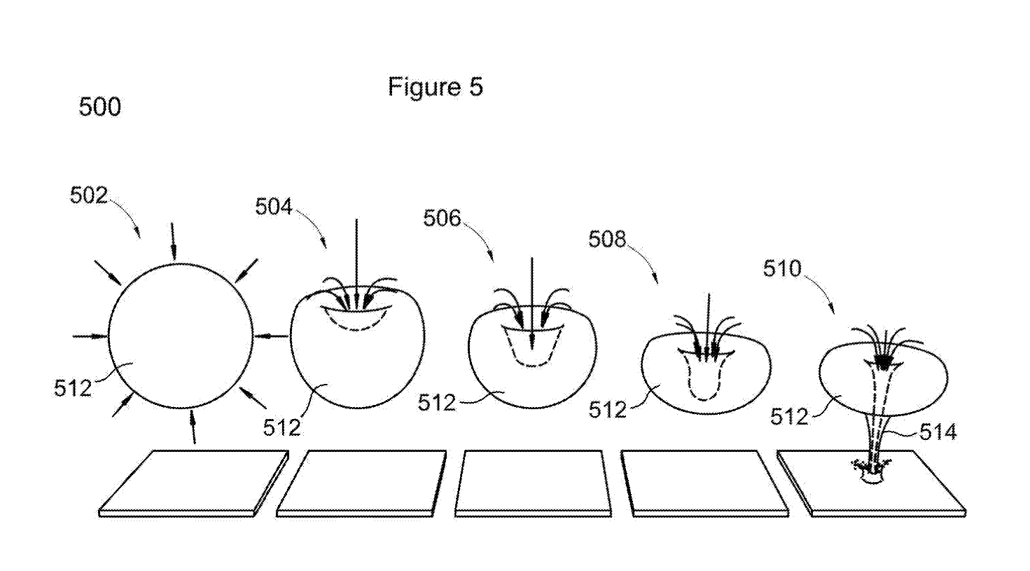

Referring to FIG. 5, a series of cross-sections of internal wall 106, of FIG. 1, is shown at 500. Each of cross-sections 502, 504, 506, 508, and 510 represent the same location on internal wall 106, but at sequential times. Cross-section 502 shows transient bubble 512 just after formation due to vibration from the cavitation inducing device. Cross-section 504 shows the beginning of the collapse of transient bubble 512. Transient bubble 512 continues to collapse in cross-section 506 and cross-section 508, with the cavitation collapse inducing microject 514 in cross-section 510. Microject 514 knocks foulant off the internal wall. While bubble 512 is shown in the bulk phase of the carrier liquid, bubble 512 may form on internal wall 106.

In some embodiments, process side 104, 204, 304, and 404 are equipped with a pressure sensor or pressure sensors, a temperature sensor or temperature sensors, or a combination thereof. In some embodiments, these sensors are located on the inlets and outlets of the process side 104, 204, 304, and 404. In other embodiments, these sensors are located at a plurality of locations on process side 104, 204, 304, and 404.

In some embodiments, the condition indicating fouling is determined by a change of pressure through process side 104, 204, 304, and 404, as indicated by the pressure sensor or pressure sensors. In some embodiments, the condition indicating fouling is determined by a change of temperature through process side 104, 204, 304, and 404, indicated by the temperature sensor or temperature sensors. In some embodiments, the condition indicating fouling is determined by both a change of pressure and a change of temperature through process side 104, 204, 304, and 404, as indicated by the pressure sensor or pressure sensors and the temperature sensor or temperature sensors.

In some embodiments, the carrier liquid comprises water, brine, hydrocarbons, liquid ammonia, liquid carbon dioxide, or combinations thereof. In some embodiments, the potential fouling agents comprise solid particles, miscible liquids, dissolved salts, a fouling gas that may desublimate onto the surface of the heat exchanger, reaction products, or combinations thereof. The fouling gas comprises carbon dioxide, nitrogen oxide, sulfur dioxide, nitrogen dioxide, sulfur trioxide, hydrogen sulfide, hydrogen cyanide, water, hydrocarbons with a freezing point above 0 C, or combinations thereof.

In some embodiments, the cavitation inducing device or cavitation inducing devices comprise a piezoelectric actuator, ultrasound emitter, carbon-arc cavitation inducer, voice coil, linear resonant actuator, shaker, exciter, hydraulic actuator, solenoid actuator, blunt object, manual shaking, or a combination thereof. In some embodiments, the cavitation inducing device or cavitation inducing devices are sealed to prevent a liquid from damaging the cavitation inducing device.

In some embodiments, the operating heat exchanger may be equipped with a cavitation detecting device, which can be used to provide feedback to a control loop to verify the system is operating correctly. In some embodiments, the cavitation detecting device or devices may comprise hydrophones, passive cavitation detectors, piezoelectric polymer-coated impedance-matched acoustical absorbers, vibration sensors, microphones, pressure sensors, ceramic capacitive measuring cells, photolitographed-micropattern cavitation detectors, two electrodes isolated from each other by an insulative surface, high intensity focused ultrasound transducers with a modular cavitation element, or combinations thereof.

In some embodiments, the cavitation inducing device or cavitation inducing devices are controlled by a control loop that monitors the condition indicating fouling and actuates the cavitation inducing device or cavitation inducing devices automatically.

In some embodiments, the condition indicating fouling is detected by an operator, at which point the operator manually actuates the cavitation inducing device or cavitation inducing devices.

In some embodiments, the condition indicating fouling is detected by an operator, at which point the operator manually uses the cavitation inducing device or cavitation inducing devices on the operating heat exchanger. In one embodiment, the operator induces cavitations by striking the heat exchanger.

In some embodiments, the heat exchanger comprises a brazed plate, aluminum plate, shell and tube, plate, plate and frame, plate and shell, spiral, or plate fin style heat exchanger. In some embodiments, any surface of the process side of the heat exchanger exposed to the carrier liquid comprises a material that inhibits adsorption of gases, prevents deposition of solids, or a combination thereof. In some embodiments, the material comprises aluminum, stainless steel, polymers, carbon steel, ceramics, polytetrafluoroethylene, polychlorotrifluoroethylene, natural diamond, man-made diamond, chemical-vapor deposition diamond, polycrystalline diamond, or combinations thereof.

1. A method for removing a surface foulant, the method comprising:
providing an operating heat exchanger with a process side operating at an operating pressure;
providing a carrier liquid that contains potential fouling agents to the process side of the operating heat exchanger, wherein at least a portion of the potential fouling agents foul at least a portion of an internal wall of the process side of the operating heat exchanger;
operating the process side of the heat exchanger such that the carrier liquid is at a vapor pressure equal to the operating pressure;
providing a cavitation inducing device or cavitation inducing devices to the process side of the operating heat exchanger;
detecting a condition indicating fouling;
operating the cavitation inducing device for a portion or portions of the process side of the operating heat exchanger to cause a localized pressure change, vaporizing a portion of the carrier liquid and forming a transient bubble or bubbles which collapse by cavitation, producing a localized shockwave, a re-entrant microjet, and extreme transient pressures and temperatures; and,
repeating as necessary to remove the surface foulant;
whereby the surface foulant is removed from the operating heat exchanger.

2. The method of claim 1, wherein the process side of the operating heat exchanger is equipped with a pressure sensor or pressure sensors.

3. The method of claim 2, wherein the pressure sensor or pressure sensors are located at an inlet and an outlet of the process side of the operating heat exchanger.

4. The method of claim 2, wherein the condition indicating fouling is determined by a change of pressure through the process side of the operating heat exchanger, indicated by the pressure sensor or pressure sensors.

5. The method of claim 1, wherein the process side of the operating heat exchanger is equipped with a temperature sensor or temperature sensors.

6. The method of claim 5, wherein the temperature sensor or temperature sensors are located at an inlet and an outlet of the process side of the operating heat exchanger.

7. The method of claim 5, wherein the condition indicating fouling is determined by a change of temperature, indicated by the temperature sensor or temperature sensors.

8. The method of claim 1, wherein the process side of the operating heat exchanger is equipped with a pressure sensor or pressure sensors and a temperature sensor or temperature sensors.

9. The method of claim 10, wherein the condition indicating fouling is determined by a change of temperature through the process side of the operating heat exchanger, indicated by the temperature sensor or temperature sensors, and by a change in pressure, indicated by the pressure sensor or pressure sensors.

10. The method of claim 1, wherein the carrier liquid comprises water, brine, hydrocarbons, liquid ammonia, liquid carbon dioxide, or combinations thereof.

11. The method of claim 1, wherein the potential fouling agents comprise solid particles, miscible liquids, dissolved salts, a fouling gas that may desublimate onto the surface of the heat exchanger, reaction products, or combinations thereof.

12. The method of claim 11, wherein the fouling gas comprises carbon dioxide, nitrogen oxide, sulfur dioxide, nitrogen dioxide, sulfur trioxide, hydrogen sulfide, hydrogen cyanide, water, hydrocarbons with a freezing point above 0 C, or combinations thereof.

13. The method of claim 1, wherein the cavitation inducing device or cavitation inducing devices comprise a piezoelectric actuator, ultrasound emitter, carbon-arc cavitation inducer, voice coil, linear resonant actuator, shaker, exciter, hydraulic actuator, solenoid actuator, blunt object, manual shaking, or a combination thereof.

14. The method of claim 1, wherein the process side of the operating heat exchanger is equipped with a cavitation detecting device or cavitation detecting devices.

15. The method of claim 14, wherein the cavitation detecting device or cavitation detecting devices comprise hydrophones, passive cavitation detectors, piezoelectric polymer-coated impedance-matched acoustical absorbers, vibration sensors, microphones, pressure sensors, ceramic capacitive measuring cells, photolitographed-micropattern cavitation detectors, two electrodes isolated from each other by an insulative surface, high intensity focused ultrasound transducers with a modular cavitation element, or combinations thereof.

16. The method of claim 1, wherein the cavitation inducing device or cavitation inducing devices are controlled by a control loop that monitors the condition indicating fouling and actuates the cavitation inducing device or cavitation inducing devices automatically.

17. The method of claim 1, wherein the condition indicating fouling is detected by an operator, at which point the operator manually actuates the cavitation inducing device or cavitation inducing devices or manually uses the cavitation inducing device or cavitation inducing devices.

18. The method of claim 1, wherein the heat exchanger comprises a brazed plate, aluminum plate, shell and tube, plate, plate and frame, plate and shell, spiral, or plate fin style heat exchanger.

19. The method of claim 18, wherein any surface of the process side of the heat exchanger exposed to the carrier liquid comprises a material that inhibits adsorption of gases, prevents deposition of solids, or a combination thereof.

20. The method of claim 19, wherein the material comprises aluminum, stainless steel, polymers, carbon steel, ceramics, polytetrafluoroethylene, polychlorotrifluoroethylene, natural diamond, man-made diamond, chemical-vapor deposition diamond, polycrystalline diamond, or combinations thereof.
